(19) United States
(12) Patent Application Publication
(10) Pub. No.: US 2019/0287116 A1
(43) Pub. Date: Sep. 19, 2019

(54) IDENTIFYING AN ENTITY

(71) Applicant: ISX IP Ltd, Road Town, Tortola (VG)

(72) Inventor: Nickolas John Karantzis, East Melbourne, Victoria (AU)

(21) Appl. No.: 16/462,461

(22) PCT Filed: Nov. 20, 2017
(86) PCT No.: PCT/AU2017/051269

§ 371 Date: May 20, 2019

(30) Foreign Application Priority Data
Nov. 21, 2016 (AU) 2016904748

(51) Int. Cl. G06Q 20/40; G06Q 20/24; G06Q 20/38

(52) U.S. Cl. CPC G06Q 20/40145; G06Q 20/382; G06Q 20/24; G06Q 20/4016

(57) ABSTRACT

The present disclosure relates to identifying an entity to a current electronic payment transaction. A computer system (100) comprises a memory unit (202) that stores instructions. A device interface (206) communicates current transaction data indicative of the current electronic payment transaction with the first entity. The current transaction data includes current identity data representing the first entity. A processor (201) of the computer system (100) that obtains the instructions from the memory unit (202). The processor (201) receives (301) the current transaction data including the current identity data via the device interface (206). The processor (201) also determines (302) whether the first entity corresponds to a second entity by matching the current identity data against an identity profile that is based on historical transactions of the second entity. The processor (201) also identifies (303) the first entity as the second entity if it is determined that the first entity corresponds to the second entity.

### CROSS-REFERENCE TO RELATED APPLICATIONS

The present application claims priority from Australian provisional patent application 2016904748 filed on 21 Nov. 2016, the content of which is incorporated herein by reference.

### TECHNICAL FIELD

The present disclosure generally relates to identifying an entity. The present disclosure includes computer-implemented methods, software, and computer systems for identify an entity to an electronic payment transaction.

### BACKGROUND

Widespread availability and use of computer systems and the Internet have resulted in electronic financial transactions becoming commonplace. The use of payment instruments such as credit cards, debit cards, charge cards, store cards, virtual cards, pre-paid cards, digital currency, eWallets, mWallets and bank accounts to purchase goods or services from online merchants or vendors is convenient. As a result of the convenience associated with electronic payment transactions, it has led to the rise of money laundering by criminal gangs, and funding of terrorists.

Anti Money Laundering (AML) and Counter Funding of Terrorism (CFT) regulations require that persons be identified if certain monetary or value thresholds have been exceeded during the course of transactions. The wide use of the internet, together with mobile devices, has given rise to compound annual growth of electronic transactions, which now has resulted in billions of remote electronic financial transactions being conducted via the internet each year. The requirement for identification of persons remote to the merchant making payment via electronic financial transactions is becoming more difficult to satisfy due to speed, distance, complexity and customers and merchants being connected across a global network.

AML/CFT regulated merchants in the past relied upon a face-to-face interview of persons, or checking copies of documents certified by qualified person and posted to the merchant. More recently, merchants have relied upon challenge and response approaches whereby a person provides data that is cross checked against pre-existing databases that contain personal data, including full name, address, date of birth, place of birth credit information, telephone number and such like. This personal data has in the past been assumed to be non-public, particularly where records where required to be manually accessed, which has now been displaced by the availability, prevalance and depth of online legal or reputable sources of information. The challenge is that such personal data may now be sourced by both those seeking to legitimately verify the identy of a person, as well a fraudsters seeking to impersonate said person.

Personal data can be sourced from credit reference agencies, government databases for example, passport databases, driver license databases, social security number databases, citizen number or tax file number databases, and from public sources including electoral rolls and telephone directories. Information regarding a person may also be obtained by fraudsters or disclosed on the internet as a result of database hacks, breaches, social engineering, phishing or self-disclosure by individuals (or their friends or relatives) on social media, data that was previously considered ‘non-public’ may now be available through a variety of legitimate and illegitimate means. The accessibility of the foregoing databases online means that a fraudster who has access to some of a person's personal data may now use that to elicit further information regarding the person from legitimate online sources. Therefore, identification of persons by use of static databases listed above is becoming less desirable, and increasingly ineffective in mitigating impersonation risks.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present disclosure is not to be taken as an admission that any or all of these matters form part of the prior art base or were common general knowledge in the field relevant to the present disclosure as it existed before the priority date of each claim of this application.

### SUMMARY

A computer system for identifying a first entity to a current electronic payment transaction comprises:

a memory unit to store instructions;

a device interface to communicate
current transaction data indicative of the current electronic payment transaction with the first entity, the current transaction data including current identity data representing the first entity, and

a processor to obtain the instructions from the memory unit, and the processor being caused by the instructions to:
receive the current transaction data including the current identity data via the device interface,
determine whether the first entity corresponds to a second entity by matching the current identity data against an identity profile that is based on historical transactions of the second entity;
identify the first entity as the second entity if it is determined that the first entity corresponds to the second entity.

It is an advantage that the identity profile, that is based on historical transactions of the second entity, can be updated dynamically and automatically. This allows a more accurate identification of the first entity over time as more historical transactions become available. This enhances accuracy of the identification of the first entity and improves security of the current electronic payment transaction.

The processor may be further caused to determine the identity profile based on the historical transaction data.

Determining whether the first entity corresponds to a second entity may comprise selecting the identity profile of the second entity based on the current identity data.

The current identity data may comprise multiple current identity data elements, the identity profile may comprise multiple profile identity data elements, and matching the current identity data against the identity profile may comprise matching at least some of the multiple current identity data elements against at least some of the profile identity data elements.

The identity profile may comprise one or more historical transactions.

The processor may be further caused to calculate a confidence level based on the identity profile of the second entity, the confidence level indicating a degree of certainty of the first identity corresponding to the second entity; and store the confidence level in association with the identity profile in the memory unit.

The processor may be further caused to identify the entity if the confidence level meets a confidence threshold.

The processor may be further caused to calculate a confidence level based on the historical transactions of the second entity, the confidence level indicating a degree of certainty of the identity profile corresponding to the second entity; and store the confidence level in association with the identity profile in the memory unit.

The identity profile may further include one or more of the following:

a photograph associated with the second entity;

an identity document representing the second entity;

a speech sample associated with the second entity;

a video sample associated with the second entity;

a video of human movement associated with the second entity;

an image of a manual signature of the second entity;

biometric data associated with the second entity;

a mobile number associated with the second entity;

an email address associated with the second entity;

an IP address associated with the second entity;

a geographic location of the second entity;

a name of the second entity;

a date of birth associated with the second entity;

citizenship associated with the second entity;

type of incorporation of the second entity;

a physical address of the second entity;

routing data in relation to the historical transactions;

payment instrument information of a payment instrument used by the second entity to conduct the historical transactions;

device data of a user device used by the second entity to conduct the historical transactions; and

software data of a software used by the second entity to conduct the historical transactions.

The biometric data may be based on one or more of the following biometric features associated with the second entity: fingerprints, hand features, facial features, retina features, iris features, heartbeat or heartrate, voice features, and gait.

The processor may be further caused to calculate a confidence level based on the photograph associated with the second entity, or the identity document representing the second entity.

The processor may be further caused to calculate a confidence level based on biometric data of one or more biometric features of the second entity, when compared to similar biometric features located on an identity document representing the second entity.

The processor may be further caused to verify the identity profile by comparing the identity profile to a verification document.

The processor may be further caused to send the identity profile to an identity profile database via the device interface.

The processor may be further caused to determine a match between the identity profile of the second entity and a further identity profile of the second entity in the identity profile database; determine the historical transaction data of one or more previous transactions conducted with the second entity; and send a message indicative of the match to a user device associated with another party to the electronic payment transaction.

The processor may be further caused to determine a match between a biometric feature associated with the second entity and a further biometric feature stored in the further identity profile of the second entity.

The processor may be further caused to determine a match between the photograph associated with the entity and a further photograph stored in the further identity profile of the entity.

The processor may be further caused to determine a match between the speech sample associated with the entity and a further speech sample stored in the further identity profile of the entity.

The current electronic payment transaction may be conducted by the first entity using a payment instrument and the processor may be further caused to determine that the first entity possesses the payment instrument.

The processor may be further caused to determine if the identity profile of the second entity matches a record associated with the second entity in a public identity database.

The processor may be further caused to determine a degree of match or mismatch between the identity profile of the second entity and the record associated with the second entity in the public identity database; calculate a confidence level based on the degree of match or mismatch; and send a message to a user device associated with another party to the current electronic payment transaction indicating the degree of match or mismatch.

The processor may be further caused to determine a name and an address of the first entity based on the entity profile of the second entity; and determine if the name and the address of the first entity match a name and an address recorded in a credit card scheme for the first entity.

The processor may be further caused to determine a degree of match or mismatch between the name and the address of the first entity and the name and the address recorded in the credit card scheme for the first entity; calculate the confidence level based on the degree of match or mismatch; and send a message to a user device associated with another party to the electronic payment transaction indicating the degree of match or mismatch.

The processor may be further caused to present a graphical user interface via a device interface to a user device used by the first entity to conduct the current electronic payment transaction; and receive, via the device interface, the transaction data from the user device.

The processor may be further caused to authenticate the current electronic payment transaction if the entity is identified.

A computer-implemented method for identifying a first entity to a current payment transaction comprises:

receiving current transaction data indicative of the current electronic payment transaction with the first entity, the current transaction data including current identity data representing the first entity, determining whether the first entity corresponds to a second entity by matching the current identity data against an identity profile that is based on historical transactions of the second entity; and identifying the first entity as the second entity if it is determined that the first entity corresponds to the second entity.

A computer software program, including computer-readable instructions, when executed by a processor, causes the processor to perform the above method.

Optional features described of any aspect of method, computer readable medium or computer system, where appropriate, similarly apply to the other aspects also described here.

### BRIEF DESCRIPTION OF DRAWINGS

Features of the present disclosure are illustrated by way of non-limiting examples, and like numerals indicate like elements, in which:

FIG. 1 illustrates an example transaction system.

FIG. 2 illustrates an example identity agent.

FIG. 3 illustrates a method for identifying an entity to an electronic payment transaction

FIG. 4 illustrates example data.

FIG. 5 illustrates a payer computer device

### DESCRIPTION OF EMBODIMENTS

The present disclosure provides a secure way to remotely and dynamically determine a person's identity, contemporaneously with the processing of an electronic payment transaction. The invention contemplates a software identity agent that may be located in whole or part on a computer, a server, a series of servers, the cloud, a mobile device, the payment network, clearing network, settlement network, card processing network, card scheme network or any other apparatus or combinations of the foregoing, with suitable computation power to analyse, process and transmit the data and metadata below.

The identification of the person could be on behalf of a merchant providing a service to a consumer, or for a financial institution, insurance company, digital currency processor, casino, betting agency, wagering company, payment processor, stock broker, securities or futures dealer, eMoney institution, eWallet operator, bullion dealer, card scheme such as Visa, Mastercard, American Express, JCB, China UnionPay, an entity that verifies identity on behalf of other entities, or any other entity that finds it desirable to identify a person remotely. A merchant is used as the example for convenience, however this should not exclude other applications.

For convenience, the embodiments are generally described using credit cards or debit cards as a financial instrument. However, it is not intended that the scope of the invention be limited in this manner as the invention has broad application to other financial instruments including, but not limited to, bank accounts, eWallets and other stored value cards.

Also for convenience, the embodiments are generally described with reference to the purchaser, who may alternatively be referred to as the customer, payer, cardholder, consumer, accountholder, buyer or the originator of the transaction and with reference to a merchant, who may alternatively referred to as the operator, business or payee.

Also for convenience, the embodiments are generally described with reference to online purchase of an item from a merchant (e.g., a vendor of physical or virtual goods, or a provider of services, also referred to as payee) by a purchaser who originates an online Card Not Present (CNP) transaction. However, it is not intended that the scope of the invention be limited in this manner as the invention has broad application to other CNP transactions, including Mail Order and Telesales Orders (“MOTO”)

The identification methods and systems described hereinafter determine the identity of the purchaser (as originator of a CNP transaction). Identity in this sense does not necessarily mean a verified person but may be a unique identifier, such as a credit or debit card, bank account, mobile phone, health care or social security number. Typically, identifiers issued by reputable third parties such as government, banking or telecommunications providers are preferable to self created and assigned identifiers such as instant message, email, social media, and the like. It is an attribute of the identifier that the person can be identified by that identifier in the sense that no other person has the same identifier, with third party identifiers being classified as “verified” or “3rd party assigned” where they originate from trusted third parties including government agencies, telecommunication providers, banking and payment providers, whilst self assigned identifiers may be classified as “unverified” or “self assigned”. This means that out of the set of all transactions across either a merchant's payment or a multi merchant payment network, a subset can be selected of those transactions that originate from the same purchaser. As this selection of a subset of transactions is based on at least one unique identifier with an associated confidence score, this is possible even in cases where the name of the purchaser is unknown.

Embodiments described hereinafter may be practised independently or in conjunction with the various methods and checks referred to in the foregoing background section.

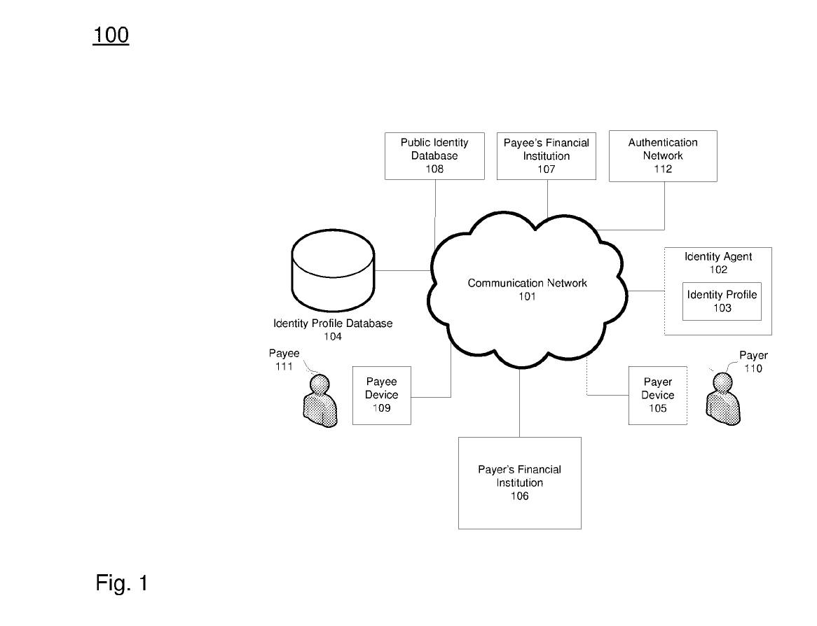

FIG. 1 illustrates an example transaction system 100 including a communication network 101, an identity agent 102, an identity profile database 104, a payer device 105, a payer's financial institution 106, a payee's financial institution 107, a public identity database 108, a payee device 109, and a authentication network 112.

The communication network 101 is a network that communicates information between the network elements in the transaction system 100, which may be for example a local area network (LAN), a wireless local area network (WLAN), a wide area network (WAN), a cellular telecommunication network, the internet, or a combination thereof.

In operation, a payer 110, such as a customer purchasing goods or services from a merchant, executes an electronic financial payment using a payment instrument, in favour of the payee 111, such as a merchant, as is typically executed every day in eCommerce applications. The payer 110 or payee 111 in the present disclosure refers to an entity including an organisation or a person. Particularly, the payer 110 uses the payer device 105 to conduct the electronic payment transaction with the payee 111.

The payer device 105 is a computing device that provides the payer 110 with access to the communication network 101. The payer device 105 can be a desktop, a laptop, a mobile phone, or a card reader that the payer 110 uses to access the communication network 101 to make a payment to the payee 111. The payer 110 provides identity data representing the payer 110 to the payer device 105 by for example entering the identity data into the payer device 105. The payer device 105 may also read the identity data from a payment card used by the payer 110, such as by camera and text recognition or NFC. The payment card includes a credit card, a debit card, a charge card, a transport card, etc. The payer device 105 sends transaction data including the identity data to the identity agent 102.

For security reasons, the identity agent 102 analyses the transaction data associated with the payment transaction made by the payer 110, and identifies the payer 110 if the identity data included in the transaction data of the payer 110 is verified, as described below in detail. If the identity data of payer 110 is verified, the identity agent 102 sends a payment request associated with the payment transaction to the payer's financial institution 106.

The payer' financial institution 106 seeks authentication of the payment transaction from the authentication network 112. The authentication network 112 is a network that provides authentication services for a transaction, for example, a payment made by the payer 110 to the payee 111. The authentication network 112 may be a financial network that can allow or reject a payment request from the identity agent 102. If the payment transaction is authenticated by the authentication network 112, the payer's financial institution 106 transfers a certain amount of funds to the payee's financial institution 107, for example, from an account associated with the payer 110 at the payer's financial institution 106 to an account associated with the payee 111 at the payee's financial institution 107. Following the transfer of the funds, the payee's financial institution 107 sends a message to the payee's device 109 indicating that the transfer of the fund is successful.

It should be noted that although the network elements in FIG. 1 are shown as separate network elements, one network element may be part of another network element either logically or physically. For example, the identity agent 102 may be part of the payer's financial institution 106, the authentication network 112 or even the payer device 105.

Further, the link between these network elements may take a variety of forms where appropriate. For example, the link may be a wireline communication link, a wireless communication link, an optical communication link, an access network, or a combination thereof.

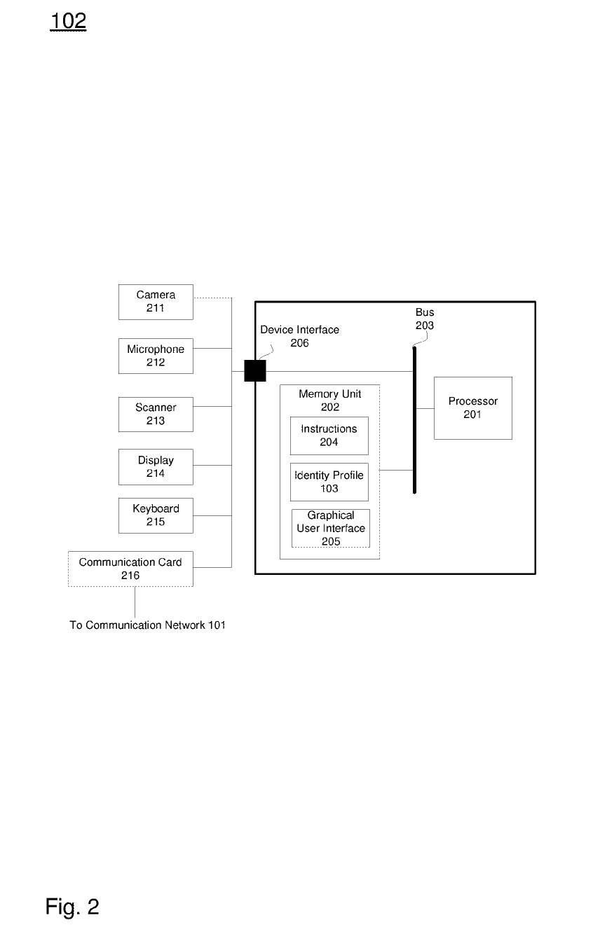

FIG. 2 illustrates an example identity agent 102 for identifying an entity to an electronic payment transaction. Identity agent comprises a processor 201 and a memory unit 202 connected by bus 203. Memory unit 202 stores instructions 204, identity profiles 103 and a graphical user interface 205, such as in the form of HTML code. Identity agent 102 further comprises a device interface 206 connecting the identity agent to a camera or series of cameras 211, microphone 212, scanner 213, display 214, keyboard 215 and communication card 216.

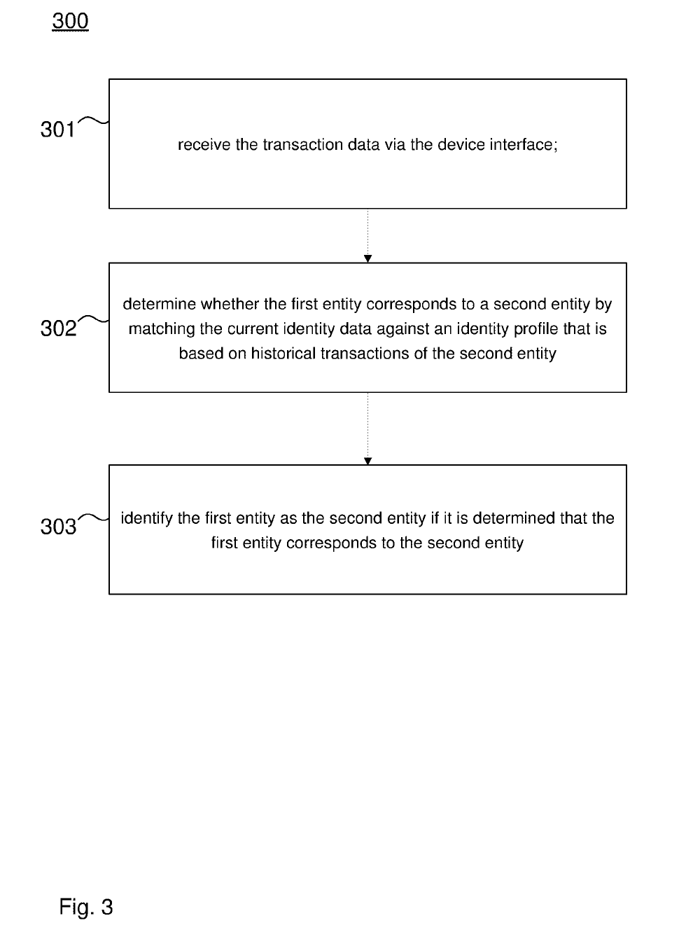

Device interface 206 communicates transaction data indicative of an electronic payment transaction with the payer 110. The transaction data includes identity data representing the payer 100. Processor 201 obtains the instructions from the memory unit 202, which causes processor 201 to perform method 300 in FIG. 3.

FIG. 3 illustrates a method 300 for identifying an entity to an electronic payment transaction. Processor 201 receives 301 the transaction data via the device interface 206 and then determines 302 whether the first entity corresponds to a second entity by matching the current identity data against an identity profile that is based on historical transactions of the second entity. Finally, processor 201 identifies 303 the payer 110 if it is determined that the first entity corresponds to the second entity.

### Transaction Data

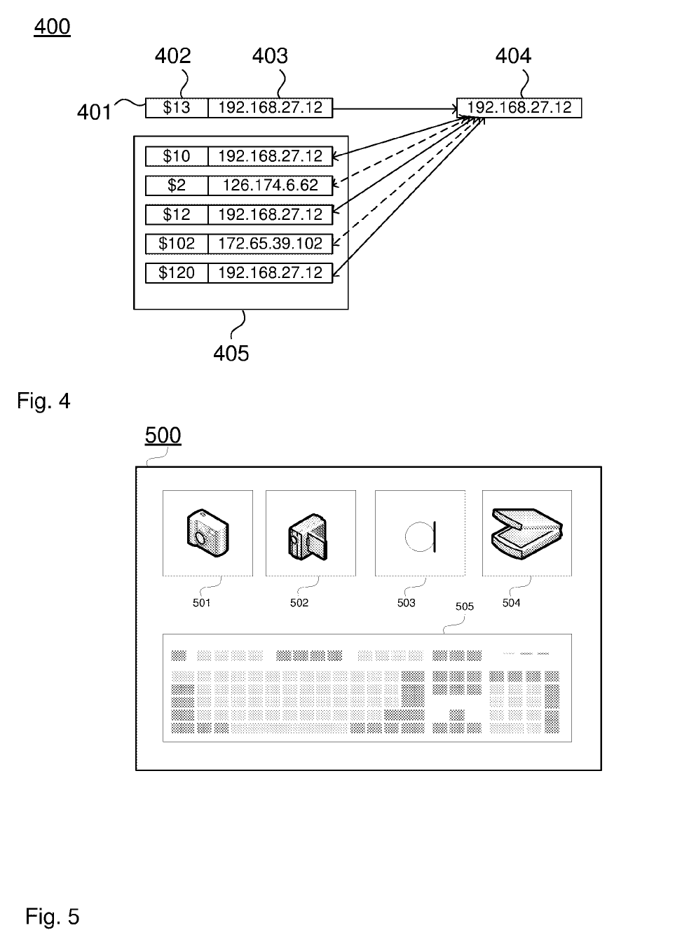

During the course of eCommerce transactions, electronic payment transactions are transmitted from the customer (payer 110) to the merchant (payee 111). FIG. 4 illustrates example data 400 comprising transaction data 401 received via device interface 206 in step 301.

The transaction data 401 comprises payload data 402 and meta-data 403. Payload data 402 may include data that relates to the payer 110 including their name, the payee 111, the payment instrument, the source of funds and the destination of the funds. The meta-data 403 may include data associated with the transmission of the electronic payment transaction over the internet, where such data may be IP address, payment routing data related to clearing houses/gateways/acquiring institutions, internet routing data related to servers, routers, hubs and switches.

In this example, the meta-data 403 comprises an IP address as identity data. However, any other meta-data including MAC addresses, phone numbers, and the like in any combination may be used as identity data. Metadata may also be collected from the customer's device, including GPS data, browser location data, browser language, device type, serial, unique identifier, operating system, operating system language, cellular number, IP address, internet service provider. The use of cookies or other commercial technologies may also be used to collect other data from the customer's device 105.

### Matching Meta-Data

Verified and unverified unique identifiers including mobile phone number, instant message address, social media profile, email address, postal address, identity or government issued identifying numbers, bank or card account details, in addition to data and metadata such as GPS data, IP address, IP address derived geolocation, telecommunications network derived geolocation, routing headers, data embedded in a distributed ledger, or metadata that identifies a customer's network domain, internet service provider, telecommunications carrier, customer premises equipment (CPE), and/or device specific data such as serial, unique identifier, IMEI or MAC address, which may be compared to identity profiles previously created and stored in the central identity database. Any matches may be notified to the merchant, and classified as originating from a 3^{rd} party or verified source, or an unverified or self assigned source. Typically, metadata is information associated with the transmission of data, and is more difficult to manipulate in real time, and in particular if there are several sources from which metadata can be derived.

Processor 201 extracts the meta-data 403 and selects based on the meta-data 403 an identity profile 404 of a second entity and in the following determines whether the second entity corresponds to payer 110. Corresponding in this context means that the identities are the same but may also mean that they are sufficiently similar or belong to the same group or organisation. In this example, the identity profile 404 comprises the IP address of the payer 110. Processor 201 has access to historical transactions 405 with various different entities to create the identity profile 404. Processor 201 now uses identity profile 404 to determine whether the payer 110 corresponds to the second entity by matching the current identity data against identity profile 404. Processor 201 may have generated a large number of identity profiles for a large number of different payers. Processor 201 can select identity profile 404 out of the large number of identity profiles using the IP address as a look-up key in the database. Processor 201 may also use multiple different meta-data elements to select the profile with the best match. Processor 201 then matches the IP address 403 of the payer 110 against the IP address in the identity profile 404. The IP address in the identity profile 404 is the IP address from historical transactions 405. In this way, the identity profile 404 represents those transactions where the IP address in the meta-data of the transactions 405 match the IP address in the identity profile 404. The matching between historical transactions 405 and the identity profile 404 is indicated by arrows in FIG. 4 where solid arrows indicate matches and dashed arrows indicate mismatches. Since the IP addresses of current payment 403 and identity profile 404 match, payer 110 is identified. That is, it is determined that the payer 110 has previously transferred $10, $12 and $120 and now the transaction for $13 is considered to be performed by the same payer since more than of either the IP address, device serial, MAC Address, mobile phone, bank account, card number, identity number or other verified or unverified identifier, data or metadata is the same. The relative strength of uniqueness of the identifier will be used to determine a confidence level.

The identification method disclosed herein may be used for a variety of different applications. For example, there may be triggers that request a higher level of identification, such as where the amount is above $10,000. In that case it may be sufficient to show that the same payer has previously performed at least one transaction of above $10,000 or has previously performed at least ten transactions between $5,000 and $10,000. For that application, processor 201 determines the identity of the payer when the transaction above $10,000 is received by selecting historical transactions from the same payer based on matching meta-data in the identity profile 404 as described above.

In yet another example, the identity of the payer has been verified for a historical transaction. This means the payer 110 has provided proof of his natural or personal identity such as by way of a passport check, which may have been online, in person, or via a videoconference. Once the identity is verified, that historical transaction can be flagged as being associated with a verified identity. When a new transaction 401 is received and the step of selecting historical transactions results in the location of a transaction with a verified identity, the payer of the new transaction 401 is identified and his identity can also be considered to be verified.

In another example, the meta-data 403 comprises multiple types of meta-data, such as an IP address and a MAC address. In that case, processor 201 may select an intersection or a union of sets of the historical transactions. In other words, processor 201 may select historical transactions that match with both of the IP address and the MAC address for a high level of confidence (intersection). Alternatively, processor 201 may select historical transactions that match with one of the IP address or the MAC address (union) for a lower confidence.

### Confidence Level

In yet another example, each element in the identity profile 404 is associated with a score, such as from 1 to 100 and processor 201 adds the scores of matching elements to determine a confidence level. For example, the IP address is associated with a score of 10 while the MAC address is associated with a score of 20. If historical transactions match only in the IP address the confidence level is 10, if they match only in the MAC address the confidence level is 20 and if they match in both the confidence level is 30. This way, the confidence level indicates a degree of certainty of the identity data representing the entity. A bank account, credit or debit card number, mobile number, government issued identifier including tax file number, social security number, national identity card number, drivers license and passport will all score a higher confidence level compared to the foregoing MAC address, as they have been issued by a 3^{rd} party, are absolutely unique, an have been issued to a specific person without the ability to be transferred, and if required can be verified by a number of means known to a person skilled in the art. Processor 201 may store the confidence level in association with the identity profile such as on identity profile database 104. A merchant or payee 111 can access the confidence level and accept payment or conduct the commercial transaction only if the confidence level is above a threshold defined for that payment or transaction.

In one example, processor 201 determines as the confidence level the highest score out of all historical transactions. That is, if one historical transaction matches in both the IP address and the MAC address but all other historical transaction match only one of the IP address or the MAC address, the confidence level is still 30. In this way, the confidence level indicates a degree of certainty of the identity data representing the entity, such as the meta-data representing the payer 110.

In one example, processor 201 calculates the confidence level using those historical transactions that have verified identities. The confidence level is calculated and stored with the payer's identity profile, where such confidence level is calculated by comparing the data and metadata information associated with at least one of either the electronic payment transaction, the payment instrument, the internet, the cellular network and the device. That is, geolocation may be determined including the use of GPS data from the payer device 105, browser location where it is recorded by the browser, IP address of device, internet service provider country, financial institution country as determined from payment instrument, customers country of residence/country of issue as shown on any documents, mobile/cellular prefix country and browser language may all be weighted individually and averaged to calculate a confidence score. Other metadata collected by the identity agent during the course of processing a transaction may also be weighted and compared, including the presence (or absence) of TOR network, the presence of proxy networks, the use of free email domains, together with third party calculated confidence scores such those offered by MXToolbox or Maxmind respectively related to the email domain or proxy network providers.

The confidence level may be calculated depending upon the attributes that match or mismatch, with (mis)matched data also being presented to the merchant 111. That is, a mismatch may reduce the confidence level by the score associated with the mismatching field. The above calculation of confidence levels also applies to matching the identity profile against public identity database 108. In other words, identity agent 102 calculates the confidence level based on the degree of match or mismatch between the identity profile 103, 404 and the records of a public identity database 108. Similarly, the confidence level may be calculated based on a degree of match or mismatch between the customer's name and address and the name and address recorded in a non publicly accessible database such as those maintained by a credit card scheme or government agency.

In some examples the identity profile 404 may also include biometric data associated with the customer or other person associated with the payer 110. Biometric data may include data that is determined via a biometric process. For instance, biometric data may represent fingerprints, hand features, facial features, retina features, iris features, heartbeat/heartrate, detecting and sampling varying pressure on a screen or tablet when forming/creating a manual signature or voice features. Biometric data may also include data representing movement of a person, such as gait. In this way, the confidence level that is determined by the processor 201 may also be based on the degree of match or mismatch between the attributes of the biometric data and the records of the public identity database 108. In other examples, the degree of match or mismatch may be determined based on the biometric data and data stored on a non-publicly accessible database such as one maintained by a government agency.

In a further example, matching or mismatching of the attributes of the biometric data may be on a variable confidence scale. In this way, matching of biometric data, such as facial features or fingerprints, may be based on a weighted confidence score for each attribute of the biometric data. Processor 201 may apply a weight to the confidence score of each attribute of the biometric data individually and include the result towards a total confidence score comprising weighted confidence scores for each attribute of the biometric data. Processor 201 may use the total confidence score, that is based on the biometric data, to calculate the confidence level.

### User Provided Data

In the case where a payment instrument is a card, such as a credit, debit, prepaid, store or charge card, the card may be digitally ingested into the payment processing system by way of a digital photo, NFC or optical scan that may include optical character recognition, any of which captures the payment instrument data including name, 16 or 19 digit primary account number, expiry, and security code, each of which forms part of the payment data payload.

In other embodiments, the user may also photograph or upload a scan of an identity document such as driver's license or passport, and the data on the face of the document may be digitally ingested by the identity agent and stored on a computer, server, cloud, portable device, mobile device, or computational device future access. Data would typically include document type, unique identity document number, issuing country/state, issuing authority, validity period, name, address and date of birth. In some embodiments, the data from the government issued document may be compared to data on government operated servers, with data matches increasing the confidence score.

In other embodiments, a biometric capture device may capture biometric data of the user (or another person associated with the payer 110) and upload the biometric data into the payment processing system. The device may capture biometric characteristics such as fingerprint, hand, facial, retina, iris, heartbeat or heartrate, voice (such as speech), or gait features.

In one example, a camera captures biometric data which may be via a digital camera. In other examples a biometric scanner or sensor may capture biometric data such as features related to fingerprints. In further examples a facial or iris/retina recognition device may capture the biometric data. The biometric scanner or sensor may also capture a heartbeat or heartrate associated with the user. In further examples a microphone may capture biometric data such as voice features (speech). In further examples, a pressure sensitive screen may track signature creation.

An image capture device may also capture the biometric data. In some examples the image capture device includes a digital camera and/or a video camera. The image capture device may include more than one shutter and lens combination. In this way, the shutter and lens may act together to enhance the resolution of the captured biometric data. In addition, the image capture device may capture images using different spectrums of light other than the normal visible spectrum.

The image capture device may also include a lens with a maximum aperture diameter (such as a ‘fast lens’). In this way, the shutter of such an image capture device may be operated rapidly in order to capture high resolution still images in rapid succession, but at a slower frame per second rate than the lower resolution video capture. The image capture device may also have a separate video camera or it may utilise one of the ‘fast lenses’ operated at a faster rate more suitable to video.

The image capture device may also capture features on the identity document that are principally discernable under ultraviolet, infra-red or other light spectra. In this way, features of the identity document that are otherwise not easily visible without such an image capture device may become discernible after capture by the image capture device. These features on the document may be known as security features and may be incorporated as part of a holographic image which may combine various security features with other visible elements.

The biometric data that is captured by the image capture device may also include an image of a person's manual signature. The image capture device may also capture behavioural biometric data such as a video of a person's human movement in creating the signature. In some examples the image capture device may capture images and/or video of a person performing certain human movement including body movements.

In other embodiments, the payer 110 may be requested to take and upload a photo of themselves. The identity agent 102 can then match the photo to one or more photos stored in the identity profile database 104 associated with the payer 110. Identity agent 102 may request the payer to perform an action in order to eliminate impersonation risk. The action may be determined by the identity agent 102 and may include the blinking of eyelids to a certain timing and number, closing eyes for a period of time, holding up a certain number of fingers from one or both hands, placing hand or hands over mouth, chin or eye or eyes, placing hands on one ear or both, or opening mouth, walking, human movement including sequencing of limbs, holding up a sheet of paper over any facial aspect, holding up a sheet of paper with a number written on where such number is determined by the identity agent 102 or other actions that involve altering the facial profile of the payer 110. For some of these options the identity agent collects a video recording to check the requested changes over time. Identity agent 102 processes the photo or video and performs object detection for objects in the photo or video to confirm that the payer 110 has performed the requested actions.

In other embodiments, the customer may be requested to provide a speech sample and identity agent 102 determines that there is a match between the speech sample and one or more speech samples stored in the identity profile database 104 associated with the payer 110.

When there is a match between the user provided data, such as a photo or speech sample, identity agent 102 may also update the confidence level of the matching identities in the identity profile database 104 since the user provided data further confirms the identity in database 104.

FIG. 5 illustrates a payer computer device 500 comprising at least one photo camera 501, at least one video camera 502, at least one microphone 503, a scanner 504 and a keyboard 505. The payer 110 can use the payer computer device 500 to provide the requested information as described above. For example, payer 110 can use the video camera 502 to capture a video of a requested facial expression.

In other embodiments, the customer may key in to a PC, Webform or Mobile device their personal identity attributes such as their name, address, date of birth, social security number, mobile number, email address, citizenship and other personally identifiable data, together with payment data related to the payment instrument that is to be used to initiate the electronic payment transaction. Where the entity is an incorporated organisation, the type of incorporation may also be used. Email and phone verification may also be incorporated using commercially available means.

In other embodiments, data and metadata from identification documents such as passports, biometric identity cards or data from payment cards may be read by a near field communication (NFC) reader in the possession of the customer, including embedded NFC readers in mobile phones. The data and metadata would then be able to add further confidence to the attributes being verified, as well as provide confidence that a passport or card is physically in the possession of the customer at the time of being identified. Useful metadata would include passport chip hardware and software revision and type, as release dates can be checked to confirm that the issue date read from the Machine Readable Zone (MRZ) or biodata page of a passport is in the correct date range and software revision for that series passport. Similarly, credit or debit card chip revision metadata can also provide information as to the likelihood of it being an authentic card.

Once payer 110 provides the requested information and identity agent 102 confirms the identity of payer 110 based on the provided information, this particular payment may be flagged as being associated with a verified identity. When, at a later stage, the identity agent 102 receives further payments which match the identity profile 103 as described earlier, such as to a minimum threshold confidence value, the identity agent 102 can conclude that the further payments originate from the same payer and are therefore also associated with a verified identity.

The metadata associated with any photographed or uploaded documents may be checked for inconsistencies such as file ‘modified’ date not being consistent with ‘created’ date, embedded location metadata being inconsistent, or document creator versus modifier attributes being different.

### Payment Instruments

The payment instrument, once it is presented to the payment network, can be distinguished by the identity agent as a certain type of instrument, and associated with the issuing financial institution. In some cases, the use of internet payments and/or banking means that the payment instrument is presented by way of payment data directly into the payment or banking network, as is the case with online banking, online payment, mobile payments or virtual terminals and cards.

The identity agent 102 determines the payment instrument type, the issuing financial institution and the country that the financial institution is located in, by use of a commercially or publicly available database. In one example, identity agent 102 maintains a whitelist of acceptable payment instrument types, a whitelist of acceptable financial institutions, and/or a black list of countries that are deemed to be of high risk.

Provided that the payment instrument is of a certain type, and that the financial institution is not located in a country such as those under United Nations or other financial, economic or trade sanction, then the payment instrument may be accepted as being suitable to use as the basis for identity, and submitted for processing as part of an electronic payment transaction.

The payer's name may then be determined from the payment payload data, and recorded against the transaction, together with the payment instrument characteristics, financial institution type, and the country where the payment instrument is located. Identity agent 102 may determine if the name and the address of the payer match a name and an address recorded in a credit card scheme for the payer 110. An identity profile for that payer is then created which includes the payer's identity attributes together with supporting data and metadata, and used to satisfy present identification requirements for the merchant 111. The identity profile is stored by the identity agent 102 for future reference to form central identity database 104.

In one example, payer 110 demonstrates control of the payment instrument. Control may be determined by means known to persons skilled in the art, including the use of Karantzis, Templeton or other commercial account authentication means, where such means provides payment instrument authentication confirmation to the merchant 111. The present invention records the data and metadata associated with the person demonstrating control of the payment instrument, in order to maintain an evidentiary log.

The verification agent 102 may compare the payer's identity profile with online information and pre-existing databases to confirm name and address, where such comparison checks may include online access to social networks, telephone directories, credit reference databases, electoral rolls, Scandinavian bankID, government maintained databases such as driver's license, vehicle registration (to confirm name and address of a person owning a vehicle), passport, age verification, social security number, immigration, citizenship, residency registers or criminal records. The identity agent 102 may check name and address with the credit card scheme.

### Centralised Identity Database

Centralised identity database 104 may be created from the customer identity profiles, and accessed on demand by merchants, independent of any electronic payment transaction. That is, the identity profiles stored on identity profile database 104 can be queried by one or more of the fields in the identity profile. For example, a merchant desires to confirm that a payer's name is associated with the IP address or device serial during the session where the person is accessing the online store. In that case, the store may have a server side identification mechanism that provides a ‘welcome back’ function without the need for cookies, stored passwords or other client side mechanisms.

The identity profile database 104 may further store payer facial images. A facial photograph of the user may be captured, verified as being current and compared to photographs of other users identity profiles stored in the central identity database 104. Any matches would be notified to the merchant.

In another example, the identity profile database 104 stores speech samples and a user's speech recording is compared to speech recordings of other users' identity profiles stored in the central identity database 104. Again, any matches would be notified to the merchant.

In another example, the identity profile database 104 stores biometric data pertaining to one or more biometric features of the user. The processor 201 may then compare a biometric feature associated with the user of the second entity to biometric features stored in the central identity database 104. Again, the processor 201 may notify any matches to the merchant.

In yet another example, the identity profile database 104 stores videos of human movement associated with the user. The processor 201 may then compare a video of the user to other videos of human movement stored in the central identity databse 104. Again, the processor 201 may notify any matches to the merchant.

### Payer Device

The payer device 105 may include similar elements to those described with reference to FIG. 2. A software identity agent may reside on instructions memory 204 in whole or part. The software identity agent may perform the following tasks:
(a) providing a unique location, irrespective of IP address. This is achieved by each software agent having a unique serial or identification number and where available from the computing device or any connected peripheral device, capturing, storing and transmitting global positioning system (GPS) location data and/or cell tower location data;
(b) capturing from the computing device a unique characteristic such as an International Mobile Equipment Identity (IMEI) or Electronic Serial Number (ESN) or UUID in the case of cellular phone, a serial number, an MAC address and any other unique characteristic of the computing device;
(c) comparing data and metadata to customer identity attributes; and
(d) cross comparing data and metadata.

The payer device 105 may further comprise a display that shows to the payer 110 a graphical user interface that can be used by the payer 110 to conduct the electronic payment transaction. The payer 110 can provide the transaction data by entering the data into the graphical user interface. The graphical user interface may be generated by identity agent 102 and the merchant forwards the user from the online store to the internet address of the identity agent. In other examples, the merchant uses an API of the identity agent 102 and generates a user interface within the online store that is then presented on the payer device to the payer 110. In this example, the API requests the data that is to be displayed from identity agent 102 before displaying the data. The data from identity agent 102 may also be requested by a software script that resides in the online store and is downloaded by payer device onto payer device 105 and executed by payer device 105. As a result, the data from the identity agent 102 does not pass through the online store in this example.

### Merchant Interface

In some examples, the identity agent 102 provides a service to the merchant 111 that allows the merchant to request or confirm the identity of the payer 110. The merchant 111 sends a request for identification to the identity agent and the request comprises the transaction data. The identity agent 102 receives and processes the request as described above. The identity agent 102 may also determine that there is a match between the identity profile of the entity and a further identity profile of the entity in the identity profile database 104. The further identity profile may be based on or may comprise historical transaction data of one or more previous transactions conducted with the entity and send a message indicative of the match to a user device associated with another party to the electronic payment transaction.

As mentioned above, identity agent 102 may send data indicating the identity of the entity as determined in step 304 of method 300 in FIG. 3 to the merchant 111. The sending of data may be performed by sending an email, HTTP or a middleware message. In other examples, the requesting of the identification may be performed by a payment processor module integrated into the online store of the merchant. For example, the merchant may call the API of a PayPal module and integrated into that API call is a routine that checks whether identification is required and if so, sends the request for identification to the identity agent 102. The routine may then process the reply from the identity agent 102 and selectively proceed with the API calls to the PayPal module. This may also comprise rejecting the electronic payment transaction with the entity if there is no a match between the identity profile of the entity and a further identity profile in the profile database 104.

In other examples, identity agent 102 provides a web-based user interface that allows the merchant 111 to see the identity of the payer 110 as determined by identity agent 102. That is, the identity agent 102 creates a display comprising an indication of the identity. The display may also comprise an indication of the confidence level or an indication of historical transactions that were found to match the identity profile 103. The historical transactions that were found to match may also be represented in aggregate form, such as total number of transactions, total amount, average amount or spread over time. This richer information gives the merchant 111 a more detailed view on level of certainty of the determined identity.

### Advantages

It is an advantage of at least one example to ameliorate merchant's fraud risk by linking the payment instrument used in the purchase to the identity profile and corresponding confidence score. Data and Metadata from subsequent transactions may be compared to prior transactions, and, where the data differs according to criteria predetermined by the merchant, the transaction may be rejected or manually reviewed.

Other advantages include that the identity agent 102 may be configured to classify as suspicious any customer profile that has a confidence score less than a predetermined value, or if a payment instrument has been used previously by a different identity profile.

It is also advantageous that the identity agent 102 may be configured to classify as suspicious any customer identity profile that does not meet a minimum of data and metadata attributes matches, or if a number of attributes match previously created identity profiles with the customer's name however not being a match, or where a confidence score is below a preset threshold.

In this way, the merchant's fraud risk is ameliorated, as the centralised identity database may have a confidence score based upon the average of all prior confidence scores upon which the present confidence score is compared, or, the agent may compare the deviation of the present confidence score to any historic confidence score. Alternatively, the change in any one or more data or metadata attributes may also indicate increased risk.

The identity agent may be used to detect identity impersonation attempts, or inconsistencies, that may indicate money laundering or terrorism funding risk or payment fraud.

It should be understood that the example methods of the present disclosure might be implemented using a variety of technologies. For example, the methods described herein may be implemented by a series of machine executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as internet.

It should also be understood that, unless specifically stated otherwise as apparent from the following discussion, it is appreciated that throughout the description, discussions utilizing terms such as “determining”, “obtaining”, or “receiving” or “sending” or “generating” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A computer system for identifying a first entity to a current electronic payment transaction, the computer system comprising:
a memory unit to store instructions;
a device interface to communicate
current transaction data indicative of the current electronic payment transaction with the first entity, the current transaction data including current identity data representing the first entity, and
a processor to obtain the instructions from the memory unit, and the processor being caused by the instructions to:
receive the current transaction data including the current identity data via the device interface,
determine whether the first entity corresponds to a second entity by matching the current identity data against an identity profile that is based on historical transactions of the second entity;
identify the first entity as the second entity if it is determined that the first entity corresponds to the second entity.

2. The computer system of claim 1, wherein the processor is further caused to determine the identity profile based on the historical transaction data.

3. The computer system of claim 1 or 2, wherein determining whether the first entity corresponds to a second entity comprises selecting the identity profile of the second entity based on the current identity data.

4. The computer system of any one of the preceding claims, wherein
the current identity data comprises multiple current identity data elements,
the identity profile comprises multiple profile identity data elements, and
matching the current identity data against the identity profile comprises matching at least some of the multiple current identity data elements against at least some of the profile identity data elements.

5. The computer system of any one of the preceding claims, wherein the identity profile comprises one or more historical transactions.

6. The computer system of any one of the preceding claims, wherein the processor is further caused to
calculate a confidence level based on the identity profile of the second entity, the confidence level indicating a degree of certainty of the first identity corresponding to the second entity; and
store the confidence level in association with the identity profile in the memory unit.

7. The computer system of claim 6, wherein the processor is further caused to identify the first entity if the confidence level meets a confidence threshold.

8. The computer system of any one of the preceding claims, wherein the processor is further caused to:
calculate a confidence level based on the historical transactions of the second entity, the confidence level indicating a degree of certainty of the identity profile corresponding to the second entity; and
store the confidence level in association with the identity profile in the memory unit.

9. The computer system of any one of the preceding claims, wherein the identity profile further includes one or more of the following:
a photograph associated with the second entity;
an identity document representing the second entity;
a speech sample associated with the second entity;
a video of human movement associated with the second entity;
an image of a manual signature of the second entity;
biometric data associated with the second entity;
pressure at various sample points associated with creating a signature
a mobile number associated with the second entity;
an email address associated with the second entity;
an IP address associated with the second entity;
a geographic location of the second entity;
a name of the second entity;
a date of birth associated with the second entity;
citizenship associated with the second entity;
type of incorporation of the second entity;
a physical address of the second entity;
routing data in relation to the historical transactions;
payment instrument information of a payment instrument used by the second entity to conduct the historical transactions;
device data of a user device used by the second entity to conduct the historical transactions; and
software data of a software used by the second entity to conduct the historical transactions.

10. The computer system of claim 9, wherein the biometric data is based on one or more of the following biometric features associated with the second entity:
fingerprints;
hand features;
facial features;
retina features;
iris features;
heartbeat or heartrate;
voice features; and
gait.

11. The computer system of claim 9 or 10, wherein the processor is further caused to:
calculate a confidence level based on the photograph associated with the second entity, or the identity document representing the second entity.

12. The computer system of claim 9, 10 or 11, wherein the processor is further caused to:
calculate a confidence level based on biometric data of one or more biometric features of the second entity, when compared to similar biometric features located on the identity document representing the second entity.

13. The computer system of any one of the preceding claims, wherein the processor is further caused to:
verify the identity profile by comparing the identity profile to a verification document.

14. The computer system of any one of the preceding claims, wherein the processor is further caused to:
send the identity profile to an identity profile database via the device interface.

15. The computer system of claim 14, wherein the processor is further caused to:
determine a match between the identity profile of the second entity and a further identity profile of the second entity in the identity profile database;
determine the historical transaction data of one or more previous transactions conducted with the second entity; and
send a message indicative of the match to a user device associated with another party to the electronic payment transaction.

16. The computer system of claim 15, wherein the processor is further caused to:
determine a match between a biometric feature associated with the second entity and a further biometric feature stored in the further identity profile of the second entity.

17. The computer system of claim 15 or 16, wherein the processor is further caused to determine a match between the photograph associated with the second entity and a further photograph stored in the further identity profile of the second entity.

18. The computer system of claim 15, 16 or 17, wherein the processor is further caused to determine a match between the video of the human movement associated with the second entity and a further video of human movement associated with the second entity stored in the further identity profile of the second entity.

19. The computer system of any one of claims 15 to 18, wherein the processor is further caused to: determine a match between the speech sample associated with the second entity and a further speech sample stored in the further identity profile of the second entity.

20. The computer system of any one of the preceding claims, wherein the current electronic payment transaction is conducted by the first entity using a payment instrument and the processor is further caused to determine that the first entity possesses the payment instrument.

21. The computer system of any one of preceding claims, wherein the processor is further caused to determine if the identity profile of the second entity matches a record associated with the second entity in a public identity database.

22. The computer system of claim 21, wherein the processor is caused to:
determine a degree of match or mismatch between the identity profile of the second entity and the record associated with the second entity in the public identity database;
calculate a confidence level based on the degree of match or mismatch; and
send a message to a user device associated with another party to the current electronic payment transaction indicating the degree of match or mismatch.

23. The computer system of any one of preceding claims, wherein the processor is further caused to:
determine a name and an address of the first entity based on the entity profile of the second entity; and
determine if the name and the address of the first entity match a name and an address recorded in a credit card scheme for the first entity.

24. The computer system of claim 23, wherein the processor is further caused to:
determine a degree of match or mismatch between the name and the address of the first entity and the name and the address recorded in the credit card scheme for the first entity;
calculate the confidence level based on the degree of match or mismatch; and
send a message to a user device associated with another party to the electronic payment transaction indicating the degree of match or mismatch.

25. The computer system of any one of preceding claims, wherein the processor is further caused to:
present a graphical user interface via a device interface to a user device used by the first entity to conduct the current electronic payment transaction; and
receive, via the device interface, the transaction data from the user device.

26. The computer system of any one of preceding claims, wherein the processor is further caused to authenticate the current electronic payment transaction if the first entity is identified.

27. A computer-implemented method for identifying a first entity to a current payment transaction, the method comprising:
receiving current transaction data indicative of the current electronic payment transaction with the first entity, the current transaction data including current identity data representing the first entity,
determining whether the first entity corresponds to a second entity by matching the current identity data against an identity profile that is based on historical transactions of the second entity; and
identifying the first entity as the second entity if it is determined that the first entity corresponds to the second entity.

28. A computer software program, including computer-readable instructions, when executed by a processor, causes the processor to perform the method of claim 27.
